(19) United States
(12) Patent Application Publication
(10) Pub. No.: US 2025/0336036 A1
(43) Pub. Date: Oct. 30, 2025

(54) IMAGE DATA COLLECTION SYSTEM, IMAGE MODEL TRAINING METHOD, AND DEVICE FOR IMPROVING IMAGE RESOLUTION

(71) Applicant: Delta Electronics, Inc., Taoyuan City (TW)

(72) Inventors: Manh Trung LE, Taoyuan City (TW); Liang Chia CHEN, Taoyuan City (TW); Wei Yun LEE, Taoyuan City (TW); Yu Ting CHENG, Taoyuan City (TW)

(73) Assignee: Delta Electronics, Inc., Taoyuan City (TW)

(21) Appl. No.: 18/766,717

(22) Filed: Jul. 9, 2024

(30) Foreign Application Priority Data
Apr. 26, 2024 (CN) 202410515252.1

(51) Int. Cl. G06T 3/4053; G06T 5/10; G06T 5/20; G06V 10/24; H04N 23/67

(52) U.S. Cl. CPC G06T 3/4053; G06T 5/10; G06T 5/20; G06V 10/24; H04N 23/67; G06T 2207/20056; G06T 2207/20132

(57) ABSTRACT

The embodiments of this application provide an image data collection system, an image model training method, and a device for improving image resolution. In this application, an image capturing device is used to capture images of an object at different focal lengths to obtain a first image and a second image respectively, and the first image and the second image are processed to obtain a first processed image with high resolution and a second processed image with low resolution, respectively. Image alignment is performed on these processed images to obtain a high-resolution and low-resolution image pair. Many high-resolution and low-resolution image pairs are collected as a training image dataset to train a model for upgrading low-resolution images to high-resolution images. The trained model can significantly improve the ability to restore image details.

### CROSS REFERENCE TO RELATED APPLICATION

This application claims the benefit of priority of China Patent Application No. 202410515252.1, filed on Apr. 26, 2024, the contents of which are incorporated by reference as if fully set forth herein in their entirety.

### TECHNICAL FIELD

The embodiments of the present application relates to image processing technologies, and more particularly to an image data collection system, an image model training method, and a device for improving image resolution.

### BACKGROUND

High-resolution (HR) video can bring better visual effects to the audience. With the development of optical imaging technology, optical coupler, and high-speed communication technology, 8K video capture, storage, and projection are already mature technologies. However, high-resolution video requires relatively large storage capacity and transmission bandwidth, and the related equipment is also expensive. Digital super-resolution (SR) technology is a very popular image processing technology nowadays. The spirit of this technology is to perform up-sampling by utilizing the spatial domain information or spatial frequency domain information of low-resolution (LR) images to estimate the optical transfer function of the optical system as shown in FIG. 1, which is different from the traditional interpolation-based up-sampling method (e.g., nearest neighbor, bilinear, bicubic, etc.).

Generally, the super-resolution technology has two kinds of approaches, that is, optical and Deep Neural Network (DNN). The optical approach relies on optical system understanding to enhance resolution, while the DNN approach employs machine learning to learn patterns from data and can adapt to a broader range of situations. Though the optical approach has higher interpretability, the noise may cause errors in the deconvolution process. The DNN approach can adopt a more complex pattern and it has better performance than the optical approach in natural images taken by the camera.

The super-resolution technology has emerged in recent years. Most of them are methods based on deep learning. The traditional interpolation and up-sampling method usually only refers to the 4 to 9 pixels around the target pixel for interpolation operation. At the same time, the deep learning network constructed with many convolutional layers can analyze the features in the image, which means a larger receptive field, so it has more nonlinear mapping capabilities than traditional interpolation methods to achieve the goal of super-resolution. Many researches in recent years have also proved the effectiveness of the deep learning methods.

High-resolution images offer more detail, but their high pixel density can increase transmission bandwidth, video storage costs, and related product costs. While using HR image sensors is the most straightforward way to obtain HR images, limitations in the manufacturing process and the cost of such sensors and optical devices often make this approach impractical for many occasions or large-scale deployments. As imaging applications and precision requirements (such as image analysis, image display, microscopy, etc.) continue to evolve, demand for higher image resolution has increased. With the widespread development and application of the super-resolution technology in video and image processing, it has become critical to develop an SR solution that satisfies the temporal and spatial continuity in video content.

Nowadays, most of the super-resolution datasets are composed of “synthetic” data which generate low-resolution images with numerical methods such as bilinear and bicubic as shown in FIG. 2. This kind of dataset can be built easily. However, the down-sample process in a true optical system is more complex than these simple models. When operating on real images, the DNN trained based on these synthesized datasets generally cannot super-resolve high frequency details to the same level of clarity and sharpness as LR images. Therefore, the use of synthetic training images has such weakness in the aspect of generation of HR images.

### SUMMARY

The embodiments of the present application provide an image data collection system, an image model training method, and a device for improving image resolution, which can improve the ability to restore image details. The technical solutions provided in the present application are described below.

According to an aspect of the embodiments of the present application, an image data collection system is provided. The image data collection system includes an image capture device, configured to capture an image of an object at a first focal length to obtain a first image and capture an image of the object at a second focal length to obtain a second image, wherein the first image and the second image are of the same resolution; a storage device, configured to store the first image and the second image captured by the image capture device; a processing module, obtaining the first image and the second image from the storage device, configured to process the first image to obtain a first processed image with a first resolution, and processing the second image to obtain a second processed image with a second resolution, wherein the first resolution is greater than the second resolution; and a registration module, obtaining the first processed image and the second processed image from the processing module, configured to perform image alignment on the first processed image and the second processed image to obtain a high-resolution and low-resolution image pair.

According to another aspect of the embodiments of the present application, an image model training method is provided. The image model training method includes obtaining an image dataset by an optical system, wherein the image dataset includes a plurality of high-resolution and low-resolution image pairs, each of the high-resolution and low-resolution image pairs includes a first training image with a first resolution obtained based on a first focal length and a second training image with a second resolution obtained based on a second focal length, the first training image and the second training image have the same or corresponding image content, and the first resolution is greater than the second resolution; and inputting the image dataset into a neural network model to train the neural network model to obtain a trained image model, wherein the first training image serves as inputs of the neural network model, and the second training image serves as training labels.

According to still another aspect of the embodiments of the present application, a device for improving image resolution is provided. The device for improving image resolution includes an input unit, configured to receive a low-resolution image; a controller, coupled to the input unit, wherein an image conversion model is deployed in the controller, and the image conversion model is configured to convert the low-resolution image into a high-resolution image, wherein the image conversion model is trained using an image dataset, the image dataset includes a plurality of high-resolution and low-resolution image pairs, each of the high-resolution and low-resolution image pairs includes a first training image with a first resolution obtained based on a first focal length and a second training image with a second resolution obtained based on a second focal length, the first training image and the second training image have the same or corresponding image content, and the first resolution is greater than the second resolution; and an output unit, coupled to the controller, configured to output the high-resolution image, wherein the resolution of the high-resolution image is higher than the resolution of the low-resolution image.

The technical solutions provided in the embodiments of the present application may achieve beneficial effects as follows.

In the embodiments of the present application, the image capturing device is used to capture images of an object at different focal lengths to obtain the first image and the second image respectively, and the first image and the second image are processed to obtain the first processed image with high resolution and the second processed image with low resolution, respectively. Image alignment is performed on these processed images to obtain a high-resolution and low-resolution image pair. Many high-resolution and low-resolution image pairs are collected as a training image dataset to train a model (e.g., a neural network model) for upgrading low-resolution images to high-resolution images. The trained model can significantly improve the ability to restore image details.

It should be appreciated that the above generic description and the following detailed description are merely for illustrating and interpreting the present application and the present application is not limited thereto.

### BRIEF DESCRIPTION OF THE DRAWINGS

For explaining the technical solutions used in the embodiments of the present application more clearly, the figures to be used in describing the embodiments will be briefly introduced in the following. Obviously, the figures described below are only some of the embodiments of the present application, and those of ordinary skill in the art can further obtain other figures according to these figures without making any inventive effort.

FIG. 1 is a schematic diagram illustrating the principle of optical transfer function in super-resolution technology.

FIG. 2 is a schematic diagram illustrating a process of generating “synthetic” training images.

FIG. 3 is a schematic diagram illustrating a process of generating “real” training images.

FIG. 4 is a schematic diagram illustrating a use of an image capture device to capture an image of an object according to an embodiment of the present application.

FIG. 5 is a block diagram illustrating an image data collection system according to an embodiment of the present application.

FIG. 6 is a schematic diagram illustrating a process of processing an object image according to an embodiment of the present application.

FIG. 7 is a schematic diagram illustrating a process to obtain a high-resolution and low-resolution image pair according to an embodiment of the present application.

FIG. 8 is a schematic diagram illustrating a cosine pattern and the spectrum of the cosine pattern in a designed scene dataset (DSD) magnification calibration process.

FIG. 9 illustrates image calibration in DSD.

FIG. 10 illustrates an example of the result of image calibration result in DSD.

FIG. 11 is a schematic diagram illustrating a process of obtaining optimal crop size based on model training method.

FIG. 12 is a schematic diagram illustrating a cropping process for generating synthetic dataset.

FIG. 13 illustrates the test result of three DNN models trained by using datasets with different crop sizes.

FIG. 14 illustrates the test result of MANtiny model trained by using datasets with different crop sizes.

FIG. 15 illustrates the test result of RFDN model trained by using datasets with different crop sizes.

FIG. 16 illustrates the test result of SRCNN model trained by using datasets with different crop sizes.

FIG. 17 is a schematic diagram illustrating a process of obtaining optimal crop size based on spectrum analysis method.

FIG. 18 is a diagram illustrating the relationship between spatial frequency and spectrum correlation.

FIG. 19 is a flowchart of training a video super-resolution model.

FIG. 20 is a flowchart of identifying a redundant image.

FIG. 21 is a gradient histogram of an image.

FIG. 22 is diagram illustrating a cross-section of the spectrum along a horizontal axis.

FIG. 23 is a diagram illustrating modulation transfer function (MTF) results yielded by various methods.

FIG. 24 is a block diagram of a device for improving image resolution according to an embodiment of the present application.

FIG. 25 is a schematic diagram illustrating deployment of a high-resolution conversion system according to an embodiment of the present application.

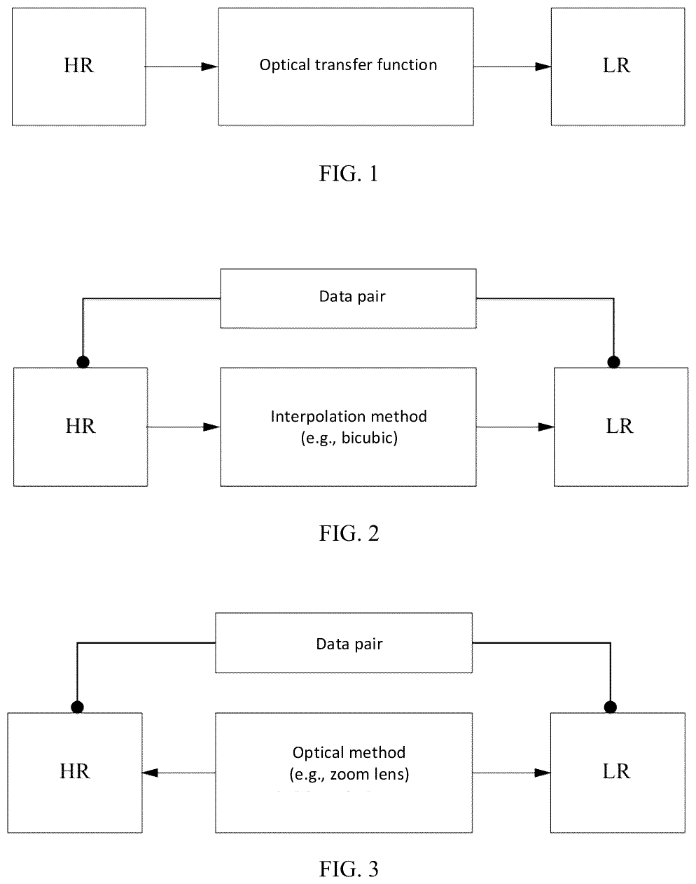

### DETAILED DESCRIPTION

The technical solutions in the embodiments of the present application will be clearly and completely described below with reference to the figures of the embodiments of the present application. Obviously, the described embodiments are merely a part of embodiments of the present application and are not all of the embodiments. Based on the embodiments of the present application, all the other embodiments obtained by those of ordinary skill in the art without making any inventive effort are within the scope sought to be protected in the present application.

In super-resolution (SR) technology, a model trained with synthetic training images is usually unable to produce high-resolution (HR) images with the same level of clarity and sharpness as low-resolution (LR) images. In the embodiments of the present application, in order to allow the model to learn the transfer function in real optical system, a “real” dataset is built as shown in FIG. 3, and the model is trained with the real dataset.

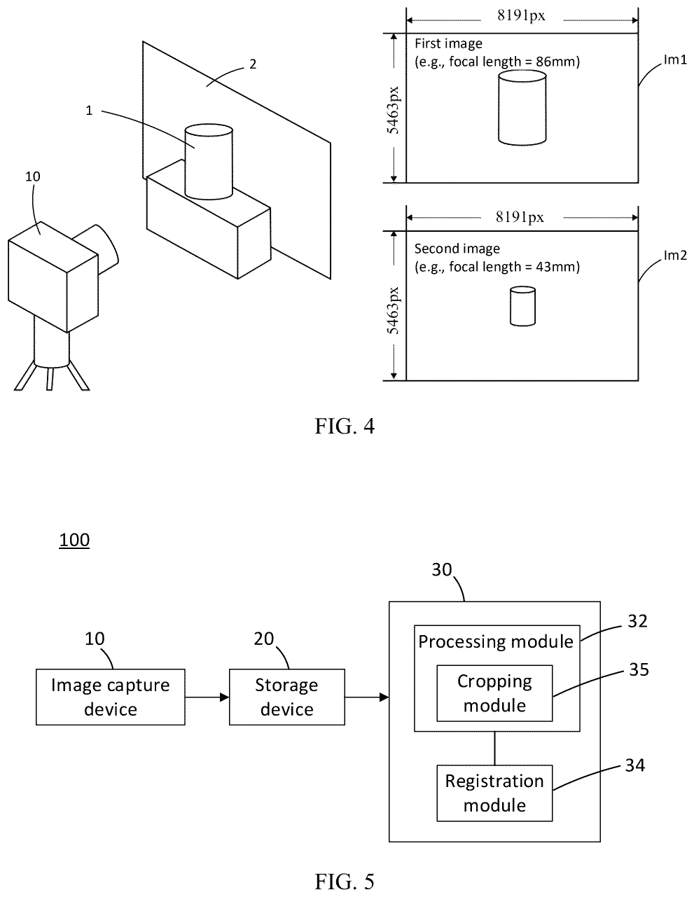

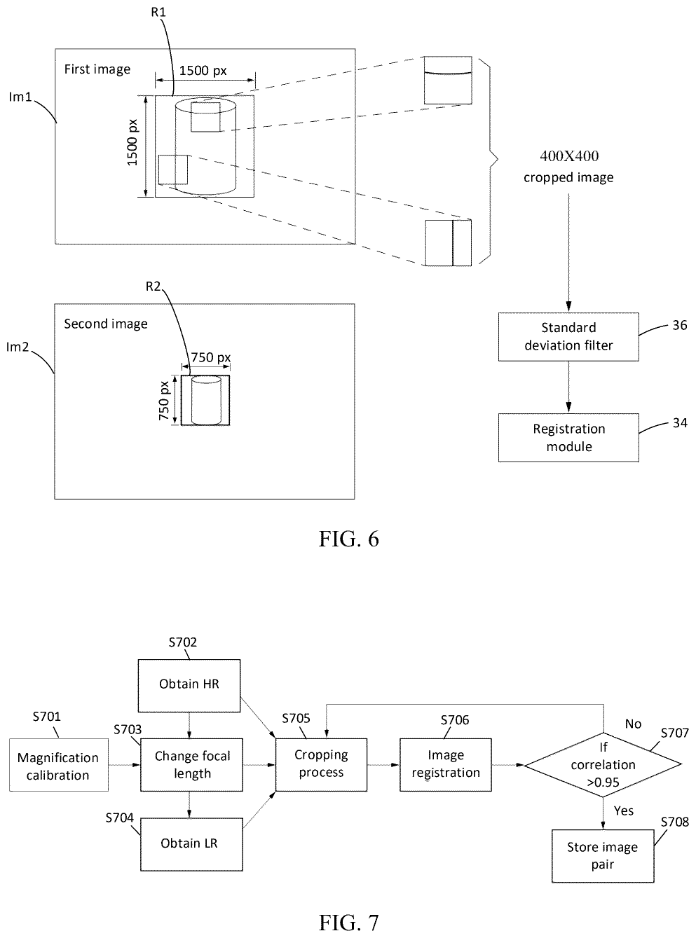

Please refer to FIGS. 4 to 6. FIG. 4 is a schematic diagram illustrating a use of an image capture device to capture an image of an object according to an embodiment of the present application. FIG. 5 is a block diagram illustrating an image data collection system according to an embodiment of the present application. FIG. 6 is a schematic diagram illustrating a process of processing an object image according to an embodiment of the present application. As shown in FIG. 5, the image data collection system 100 of the embodiments of the present application includes an image capture device (e.g., a camera lens) 10, a storage device 20, and a computing device 30. The storage device 20 can be deployed in the image capture device 10 or in the computing device 30. The computing device (e.g., a computer) 30 is provided with a processing module 32 and a registration module 34. The processing module 32 includes a cropping module 35. These modules 32, 34, and 35 can be implemented in hardware, software, firmware, or a combination of hardware and software.

As shown in FIG. 4, the image capture device 10 is configured to capture an image of an object 1 to obtain an object image. In the process of image capturing, the object 1 can be placed in front of a solid-color curtain 2 such that the captured image of the object 1 has a plain color background, facilitating subsequent image processing. The image capture device 10 includes or is a zoom lens, which captures an image of the object 1 at a first focal length (e.g., the focal length=86 mm) to obtain a first image Im1 and captures an image of the object 1 at a second focal length (e.g., the focal length=43 mm) to obtain a second image Im2. The first image Im1 and the second image Im2 captured by the image capture device 10 are of the same image size and the same resolution. When the first focal length of the image capture device 10 is greater than the second focal length, the size of the object 1 in the first image Im1 will be larger than the size of the object 1 in the second image Im2, as shown in FIG. 4.

The first image Im1 and the second image Im2 captured by the image capture device 10 may be stored in the storage device 20 which is equipped in the image capture device 10 or may be transmitted to the computing device 30 and stored in the storage device 20 of the computing device 30. The storage device 20 may be a non-volatile storage device or a volatile storage device.

The computing device 30 obtains the first image Im1 and the second image Im2 from the storage device 20. The processing module 32 of the computing device 30 is configured to process the first image Im1 to obtain a first processed image with a first resolution and process the second image Im2 to obtain a second processed image with a second resolution.

The first resolution of the first processed image is greater than the second resolution of the second processed image. The images captured by the image capture device 10 at a longer focal length have richer local details, while a larger field of view is obtained but the details are less clear for the images captured at a shorter focal length. Therefore, it would be better to obtain a high-resolution image at longer focal length and obtain a low-resolution image at shorter focal length. If the first focal length is f1 and the second focal length is f2, for f1 and f2, there has the following relation: f1=A*f2, where A>1. Then, since it would like to capture the high-resolution image at long focal length and capture the low-resolution image at short focal length, if the first resolution of the first processed image is X, then the second resolution of the second processed image can be X/A. That is to say, the ratio between the first focal length and the second focal length can be used to determine the ratio between the first resolution and the second resolution. This is because the image magnification is proportional to the focal length, and the image resolution yielded in this case is related to the image magnification. For example, the first resolution is twice the second resolution. For example, the first resolution is 8K and the second resolution is 4K. In other embodiments, another ratio between the first resolution and the second resolution can also be implemented. It is not limited to a twofold ratio. If A=2, the obtained first processed image and second processed image can be used to train a model that is suitable for improving the image resolution by two times.

Specifically, referring to FIG. 6, the cropping module 35 in the processing module 32 can crop a first area R1 in the first image Im1 to obtain the first processed image and crop a second area R2 in the second image Im2 to obtain the second processed image, wherein the image content of the first area R1 corresponds to the image content of the second area R2, and the first area R1 is larger than the second area R2. Since the size of the first area R1 is larger than the size of the second area R2, the resolution of the first area R1 is greater than the resolution of the second area R2. If the first focal length is f1 and the second focal length is f2, for f1 and f2, there has the following relation: f1=A*f2, where A>1. Then, if the resolution of the first area R1 is X, the resolution of the second area R2 can be X/A. If A=2, the obtained first area R1 and second area R2 can be used to train a model that is suitable for improving the image resolution by two times. For example, as shown in FIG. 6, the resolution of the first area R1 is 1500×1500, and the resolution of the second area R2 is 750×750. That is, the first resolution of the first processed image corresponding to the first area R1 is greater than the second resolution of the second processed image corresponding to the second area R2.

The image data collection system 100 may further include a standard deviation filter 36 configured to determine whether to remove or keep the cropped image of the first area R1 based on the standard deviation of grayscale values of the first image Im1 and the standard deviation of grayscale values of the image of the first area R1. For example, if the standard deviation of grayscale values of the cropped image of the first area R1 is greater than (or equal to) R times (R ranges from 0 to 1, such as 0.5) the standard deviation of grayscale values of the first image Im1, it means that the image of the cropped first area R1 contains the details of the first image Im1 and is thus suitable for being a training image for training a model. If the standard deviation of grayscale values of the cropped image of the first area R1 is less than R times (R ranges from 0 to 1, such as 0.5) the standard deviation of grayscale values of the first image Im1, it means that the image of the cropped first area R1 lacks the details of the first image Im1, and the cropped area may be a background image or the like that is not suitable for being a training image for training a model. Therefore, by using the standard deviation filter 36, suitable cropped images can be kept and inappropriate cropped images can be removed, thereby further improving the quality of a training image dataset. If the standard deviation filter 36 decides to keep the image of the cropped first area R1, an area (i.e., the second area R2) of the second image Im2 that corresponds to the first area R1 of the first image Im1 will be cropped later.

The registration module 34 obtains the first processed image and the second processed image from the processing module 32. The registration module 34 is configured to perform image alignment on the first processed image and the second processed image to obtain a high-resolution and low-resolution image pair. The first processed image and the second processed image may be aligned by employing a suitable algorithm, for example, the image alignment may be performed based on a difference between phase maps of spectrum of the first processed image and the second processed image. The registration module 34 can register the aligned first processed image and second processed image as an image pair. This image pair is composed of a high-resolution image and a low-resolution image. As a result, it is called a high-resolution and low-resolution image pair. This image pair can be stored in the storage device 20 or other storage devices and can be used as a training image pair to train a model (e.g., a neural network model). The second processed image serves as inputs of the model, and the first processed image serves as outputs of the model. The dataset consisting of many high-resolution and low-resolution image pairs can be called a designed scene dataset (DSD). Introducing the DSD into the process of model training is a valuable enhancement that can significantly improve the model's ability to recover image details in the process of upscaling from low-resolution images to high-resolution images (e.g., 4k images to 8k images).

In the embodiments of the present application, the image capturing device is used to capture images of an object at different focal lengths to obtain the first image and the second image respectively, and the first image and the second image are processed to obtain the first processed image with high resolution and the second processed image with low resolution, respectively. Image alignment is performed on these processed images to obtain a high-resolution and low-resolution image pair. Many high-resolution and low-resolution image pairs are collected as a training image dataset to train a model (e.g., a neural network model) for upgrading low-resolution images to high-resolution images. The trained model can significantly improve the ability to restore image details.

FIG. 7 is a schematic diagram illustrating a process to obtain a high-resolution and low-resolution image pair according to an embodiment of the present application. As shown in FIG. 7, the process includes magnification calibration (Step S701), obtaining a high-resolution image (Step S702), changing the focal length (Step S703), obtaining a low-resolution image (Step S704), a cropping process (Step S705), image registration (Step S706), similarity judgement (Step S707), storing an image pair (Step S708), and etc.

Natural images taken by a camera have uncertainty, such as noise, distortion, aberration, and error induced by the environment. To reduce these uncertainties, it needs to control the acquisition of the dataset in the designed environment. High-resolution images and low-resolution images are taken by changing the focal length of the zoom lens. For example, after a high-resolution image is captured (Step S702), the focal length of the zoom lens can be changed (Step S703) such that the focal length is reduced to a half of the original focal length to obtain a low-resolution image (Step S704). Thereafter, the obtained high-resolution image and low-resolution image are subjected to a cropping process (Step S705). In the cropping process, a certain ratio is kept between the image size of the high-resolution image and the image size of the low-resolution image. For example, in the case of A=2, if the high-resolution image is 1500×1500, the low-resolution image is 750×750; if the high-resolution image is 400×400, the low-resolution image is 200×200.

The curtain 2 can be set as a white background, and it has two benefits. First, the white background has a small grayscale range, and it is easier to use the afore-mentioned standard deviation filter 36 to determine whether the image of the cropped area contains image details. Second, the depth of focus is small in the high-resolution situation, which means the background becomes blurrier. If the blurrier HR is taken into the training dataset, the model will learn how to blur the image, which is not the purpose of model training. A white background exhibits similar properties when in focus and defocus. It can lower the error from the defocus. To reduce the effect of the distortion, one can select only the middle area of the image for the cropping.

The flowchart of the designed scene dataset (DSD) preparation is provided as shown in FIG. 7. It contains two core processes: magnification calibration (Step S701) and image registration (Step S706). With these Steps S701 and S706, the uncertainty caused by zoom lens adjustment and camera shift can be reduced.

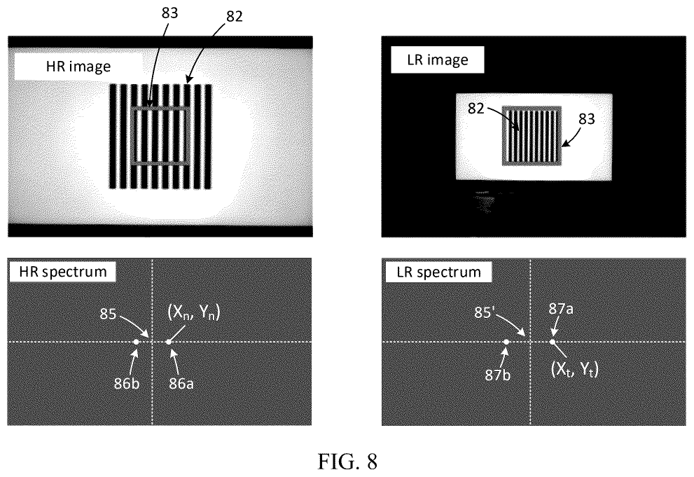

In the magnification calibration (Step S701), the magnification calibration can be performed on a calibration image to determine the position of a focus adjusting knob of the image capture device at the first focal length and the second focal length respectively such that the first image Im1 and the second image Im2 can be captured at the first focal length and the second focal length, respectively. The magnification is calibrated with two methods: cosine pattern spectrum method and Fourier Mellin transform. Based on this, a focal length restrictive mechanism is added such that the focus adjusting knob can be turned to the same position each time the image is magnified. Preferably, taking double magnification for example, the bias between the double magnification and the calibration result is smaller than 0.0025. As shown in FIG. 8, the calibration image (e.g., a cosine pattern 82) is used to calibrate the magnification. Middle areas 83 are cropped from the cosine pattern 82 in the HR image and the LR image, respectively. The size of the middle area 83 of the HR image is the same as that of the middle area 83 of the LR image. The middle areas 83 of the HR image and the LR image are subjected to fast Fourier transform (FFT) to obtain their spectrum diagrams, respectively, as shown in two diagrams at the bottom of FIG. 8. For the HR spectrum, the distances between two peaks 86a and 86b and the spectrum center 85 are equal. Similarly, for the LR spectrum, the distances between two peaks 87a and 87b and the spectrum center 85′ are equal. In the spectrum of the high-resolution (HR) image, the period is larger, the frequency is lower, and two peak positions are closer to the spectrum's center. With Fourier transform property, the magnification can be calculated by the peak distance in spectrum of the high-resolution image and the low-resolution image. For example, if the magnification is two times (i.e., A=2), the distance (or average distance) between the two peaks 87a, 87b and the spectrum center 85′ in the LR spectrum will be twice the distance (or average distance) between the two peaks 86a, 86b and the spectrum center 85 in the HR spectrum.

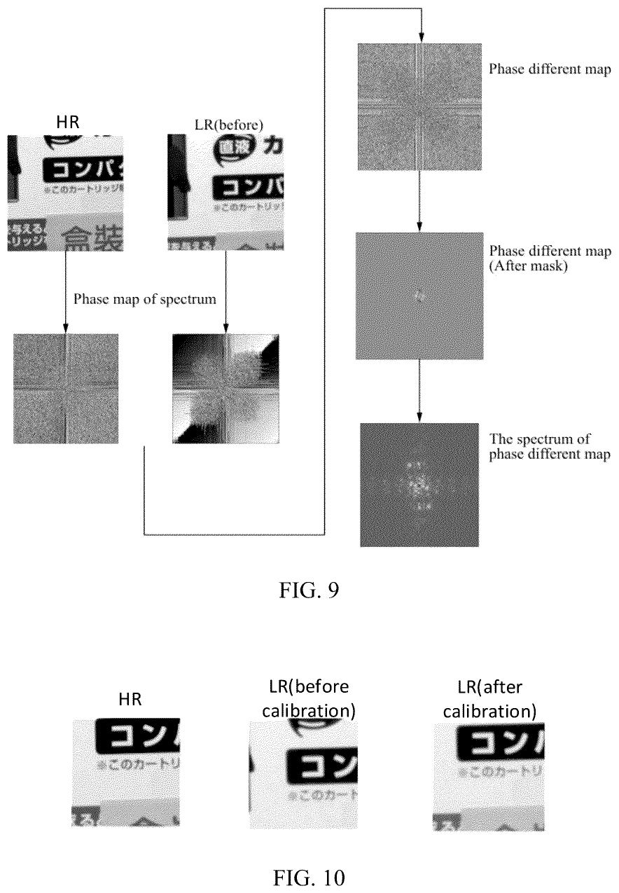

In the DSD, this application obtains the high-resolution images and the low-resolution images by changing the focal length of the camera. However, the camera field of view (FOV) might have shifted, and directly cropping the image pair might contaminate the dataset. In the image registration (Step S706), two cropped images are placed into the same FOV, and the image alignment can be performed based on a difference between phase maps of spectrum of the two cropped images, as shown in FIG. 9. That is, in Step S707, in this field of view, if the error between the two cropped images is too large (e.g., the difference between the two exceeds a certain value, such as 5%), then the cropping or alignment is performed again; if the error between the two cropped images is small (e.g., the correlation between the two is greater than a certain value, such as 95%), then they can be stored as an image pair (Step S708). FIG. 10 illustrates an example of the result of such image calibration.

The computer may not afford the computation power needed for high-resolution image datasets (e.g., datasets consisting of 4k to 8k images). To make the dataset become trainable, the images can be cropped to a small size. To determine which image size can lead to satisfactory training performance, two strategies for determining the optimal image size are proposed below.

### Model Training Method:

Obtaining a minimum or optimal crop size that does not affect the performance of a model can be carried out by the following steps: obtaining a high-resolution image and a low-resolution image having image content corresponding to the image content of the high-resolution image; cropping the high-resolution image based on a plurality of different sizes and capturing the same region in the low-resolution image to obtain a high-resolution and low-resolution image pair; and determining the minimum crop size based on a result of model training with a use of the high-resolution and low-resolution image pair for each of the sizes.

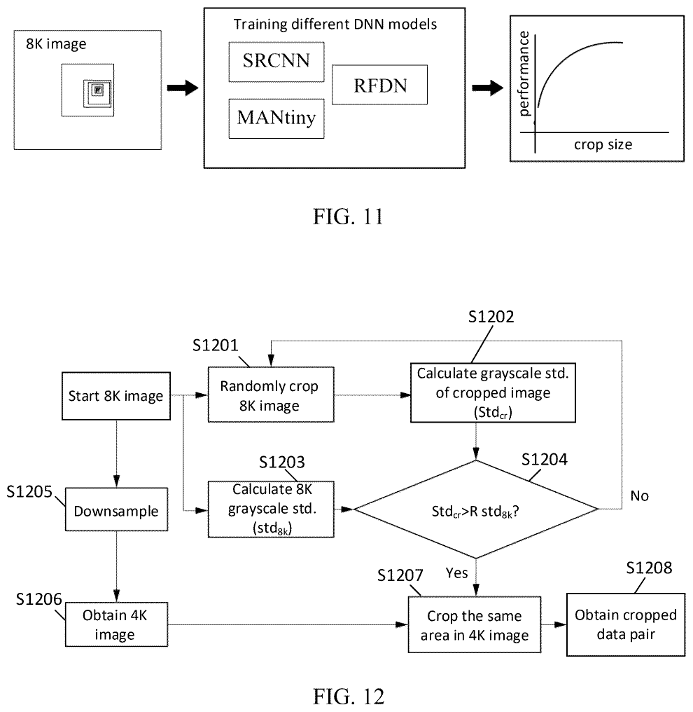

Specifically, this method uses training datasets with different crop sizes to train the model. For the training dataset, images can be collected from the exiting image dataset (e.g., UHD8k Dataset). The UHD8k Dataset provides 2029 8K (7680×4320) images. Though the dataset has a high resolution, due to the limitation of the computer's hardware and speed of training, it needs to crop them into a small size. For example, the dataset is cropped in different square sizes: 2000, 1000, 800, 400, 200, 100, 80, 70, 60, 50, 30, 20. To let the feature in every crop size has the same property, the small-size dataset is cropped from the big-size dataset. To ensure the relationship between crop size and training performance is suitable for different CNN models, three different models (i.e., MANtiny, SRCNN, and RFDN) are selected to perform the test. The process of the model training method is presented in FIG. 11.

The cropping process for an 8K image is shown in FIG. 12. As shown in FIG. 12, the process starts from the 8K image and crops the 8K image randomly (Step S1201). The process continues until the smallest size of the image is saved. In Steps S1202, S1203 and S1204, standard deviation test is performed. The standard deviation test is to test whether the image has some features to let the models learn. Generally, the background is a color block with a small grayscale change. To ensure the feature in 8K images is cropped, it can take the standard deviation of grayscale values as an index. First, the standard deviation of grayscale values Stder of the cropped image is calculated (Step S1202), and the standard deviation of grayscale values Stdsk of the 8K image is calculated (Step S1203). A comparison between the two is performed in Step S1204. For example, if the standard deviation of grayscale values of the cropped image is greater than (or equal to) R times (R ranges from 0 to 1, such as 0.5) the standard deviation of grayscale values of the 8K image, it means that the cropped image contains the details of the 8K image and is thus suitable for being a training image for training a model. If the standard deviation of grayscale values of the cropped image is less than R times (R ranges from 0 to 1, such as 0.5) the standard deviation of grayscale values of the 8K image, it means that the cropped image lacks the details of the 8K image, and the cropped area may be a background image or the like that is not suitable for being a training image for training a model, and it needs to return to Step S1201 to perform the cropping once again. In addition, the 8K image is down sampled (Step S1205) to obtain a 4K image (Step S1206). For example, “Lanczos” method may be applied to generate low-resolution (e.g., 0.5× resolution) images. Then, an area having the same or similar image content as that of the cropped image obtained from Step S1201 and satisfying the condition in Step S1204 is cropped from the 4K image (Step S1207), thereby obtaining a cropped data pair (Step S1208).

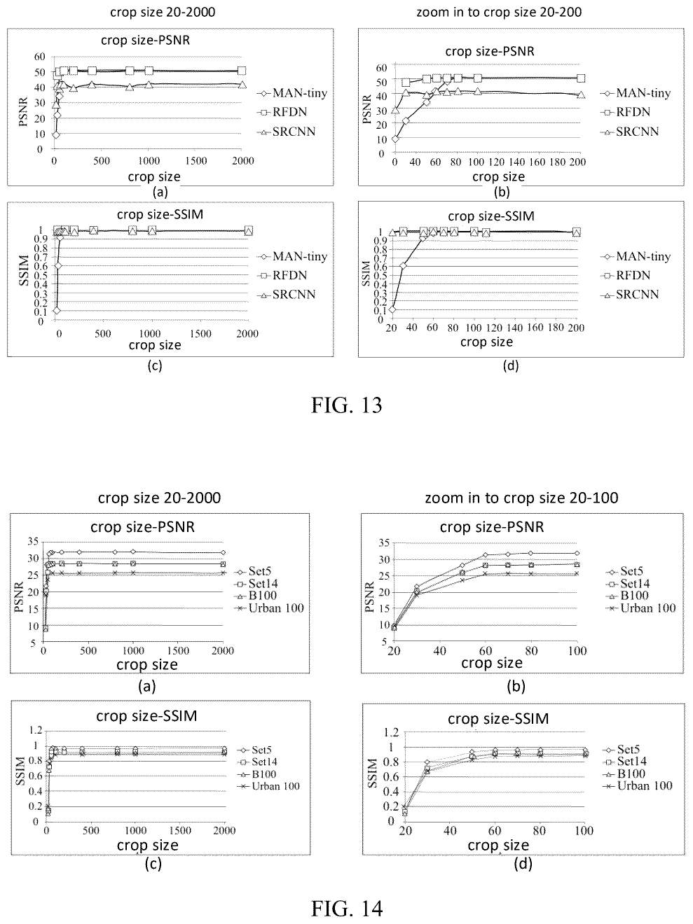

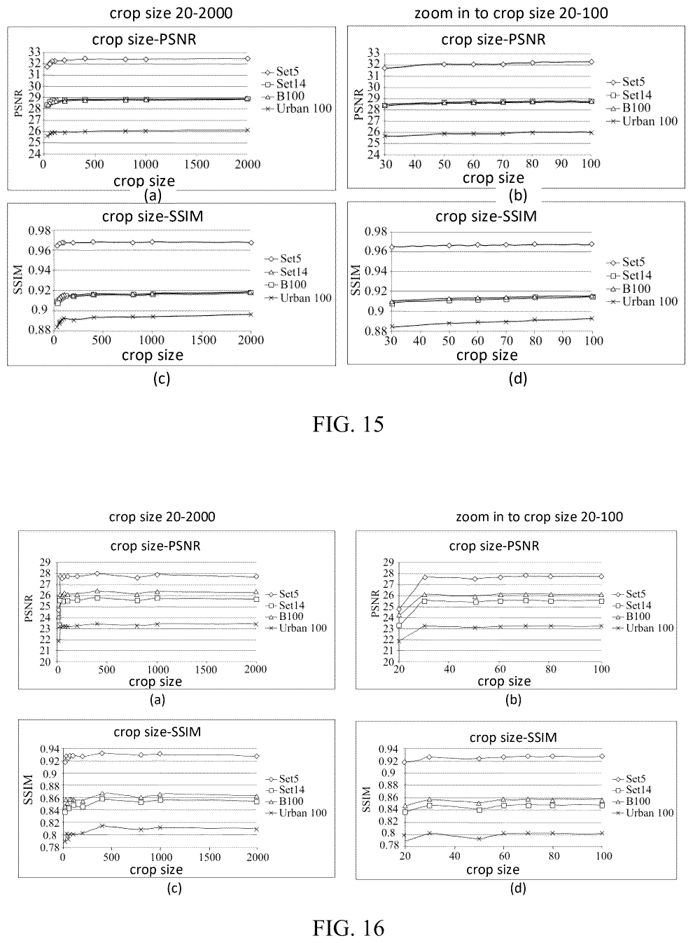

For each model, the fluctuation is smaller than 1% after crop size=100×100 and the results are presented in FIGS. 13 to 16.

### Spectrum Analysis Method:

Obtaining a minimum or optimal crop size that does not affect the performance of a model can be carried out by the following steps: obtaining a high-resolution image and a low-resolution image having image content corresponding to the image content of the high-resolution image; performing a fast Fourier transform on the high-resolution image and the low-resolution image to obtain a high-resolution image spectrum and a low-resolution image spectrum, respectively; for low-frequency areas in the high-resolution image and the low-resolution image, cropping the high-resolution image and the low-resolution image based on a plurality of different sizes; and determining the minimum crop size from these sizes based on correlation between the high-resolution image spectrum and the low-resolution image spectrum at these sizes.

Specifically, an image is composed of many plane waves with different frequencies. The cropping process can be seen as blocking the signal outside the cropped area. The bigger the crop size, the lower frequency of structure can be included.

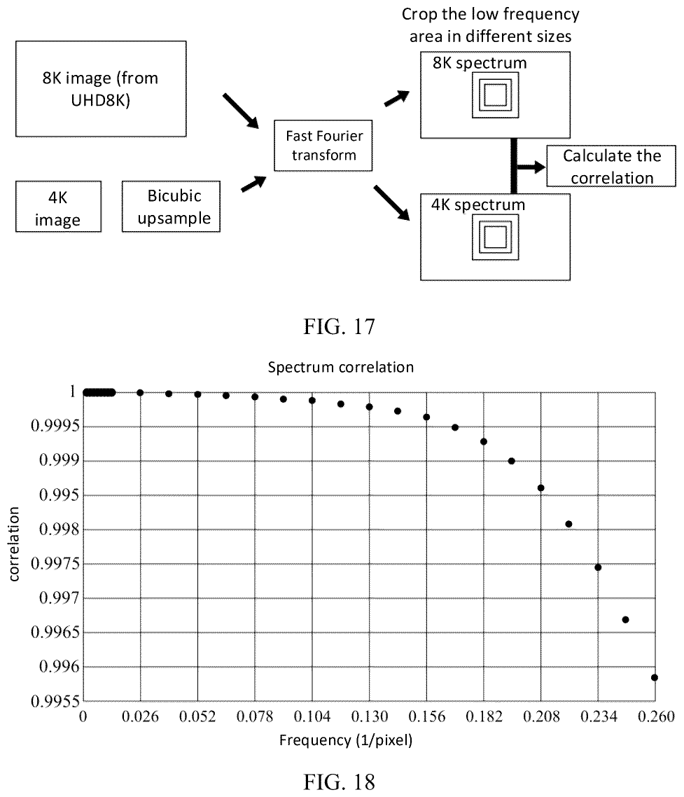

It would like to figure out at which frequency, high-resolution images and low-resolution images start to have differences in the spectrum. To get this information, the low-frequency area is cropped with different sizes. The entire flowchart is shown in FIG. 17. By calculating the spectrum correlation of multiple images from the existing data set (e.g., UHD8k Dataset), it can be plotted the relationship between correlation and frequency as shown in FIG. 8. After the frequency is determined, it can be analyzed how the cropping process affects the spectrum. When the crop size becomes smaller, the distortion will happen in the spectrum, resulting in information loss. By cropping the simulated signal with different sizes, it can be determined which crop size is safe for preventing information loss. As can be seen from the result shown in FIG. 18, at the frequency>0.052 1/pixel, the difference between 4K and 8K spectrum becomes significant.

It can be known from the two afore-described strategies, it can be concluded that the dataset is adequate at a crop size>100×100. However, to ensure the stability in critical situations, the crop size=400×400 can be selected as a criterion.

The embodiments of the present application further provide an image model training method. The image model training method includes obtaining an image dataset by an optical system, wherein the image dataset includes a plurality of high-resolution and low-resolution image pairs, each of the high-resolution and low-resolution image pairs includes a first training image with a first resolution obtained based on a first focal length and a second training image with a second resolution obtained based on a second focal length, the first training image and the second training image have the same or corresponding image content, and the first resolution is greater than the second resolution; and inputting the image dataset into a neural network model to train the neural network model to obtain a trained image model, wherein the first training image serves as inputs of the neural network model, and the second training image serves as training labels.

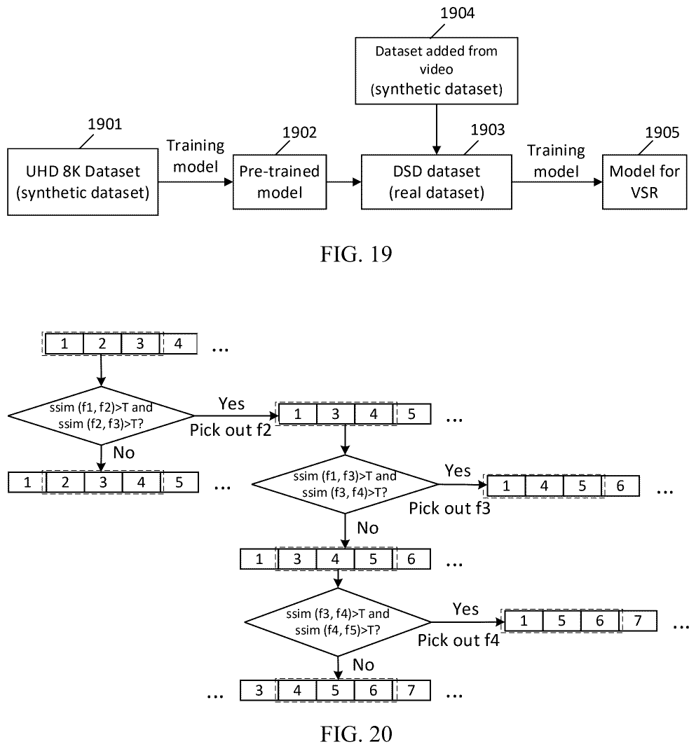

FIG. 19 is a flowchart of training a video super-resolution model. First, the UHD8k Dataset 1901 is used for training. The UHD8k Dataset is a synthetic dataset. The synthetic dataset can be used for pre-training to obtain a pre-trained model 1902. Then, the pre-trained model 1902 is further trained by using the designed scene dataset (i.e., DSD) 1903 consisting of real data to obtain a final video super-resolution (VSR) model 1905. In addition to the DSD, more high-resolution and low-resolution image pairs can be obtained from the video and serve as a dataset (which belongs to a synthetic dataset) 1904 for performing the model training to obtain the VSR model. The video super-resolution model can be used to improve the resolution of a video/film, where each frame passes the super-resolution model to make the resolution increased by two times, for example.

In the process of obtaining more high-resolution and low-resolution image pairs from the video and serving that as the dataset to participate in the model training, representative images are mainly extracted from the video to generate high-resolution version and low-resolution version of the representative images to participate in the training. To prevent the training result from overfitting from repetitive images, at least one of redundant images or blurred images in the video can be further excluded, and the remaining images in the video serve as the representative images. Specifically, the redundant images can be identified by comparing similarity between neighboring image frames, and the blurry images can be identified by evaluating sharpness of the images.

Before the images are captured from the video, the input high-resolution video (e.g., 8K video) can be downscaled (e.g., reduced to 1/16 of the original version) by using the bicubic method to reduce the calculation time in subsequent steps. After the redundant images and the blurred images in the video are identified, the frame number of the unqualified frames are recorded such that these frames are executed from being served as the dataset for the model training.

The flowchart of redundant image identification is shown in FIG. 20. A sliding window containing three frames is used to move over the video frames. Structural Similarity Index (SSIM) between first frame and second frame is calculated, as well as the SSIM between third frame and second frame. The second frame is identified as a redundant image if these SSIM values are higher than a redundant threshold (Tᵣ).

That is, if SSIM(f₂, f₁)>Tᵣ and SSIM(f₂, f₃)>Tᵣ, f₂ is redudant image.

In the subsequent calculations, the first frame is kept if the second frame is identified as a redundant image. Otherwise, the second frame becomes a new first frame.

In blur detection, a threshold (S_{intensity}) is first set to detect fade-in and fade-out frames with the mean grayscale of frames. It means a scene change is detected if SSIM between neighboring two frames is smaller than the threshold (T_{sc}). That is, if SSIM(fᵢ, fᵢ₋₁)<T_{sc}, then fᵢ will be taken as first frame of the new scene. Then, calculate the sharpness of the first frame in the scene and take it as reference sharpness (S_{ref1}, S_{ref2}). If the following frame's sharpness (Sᵢ₁, Sᵢ₂) is smaller than the product of the reference sharpness and the blur threshold (T_{b1}), this frame is said to be blurred. That is, if Sᵢ₁<T_{b1}×S_{ref1} or Sᵢ₂<T_{b1}×S_{ref2}, then fᵢ is blurred. The sharpness of an image can be calculated by two methods: gradient-based method and spectrum-based method. The reference sharpness S_{ref1} and S_{ref2} can be obtained by the two methods, respectively. The Sᵢ₁ and Sᵢ₂ are also obtained by the two methods, respectively.

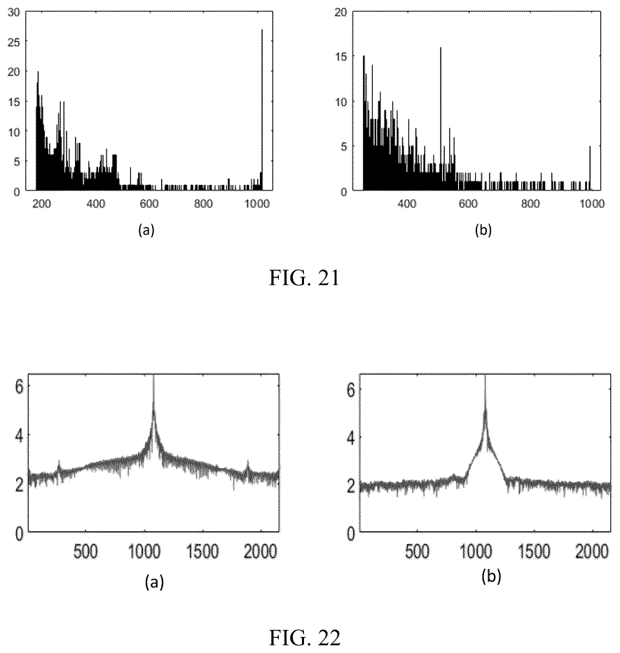

The gradient-based method is described as follows. An image can be considered as a sharp image if it contains a significant number of sharp edges, indicating that the intensity of the gradient map for sharp images is higher than the intensity of the gradient map of blurred images. By applying Laplacian derivatives, the gradient map of the image can be obtained, and a histogram can be used to represent the distribution of the gradient intensity. As shown in FIG. 21, a histogram of the gradient of a blurred image is shown by (a) on the left side of FIG. 21, while a histogram of the gradient of a sharp image is shown by (b) on the right side of FIG. 21. For the distribution of the gradient map, sharp images have variance than blur ones which means standard deviation can also be an index of sharp images. The sharpness of images can be calculated with two indexes in the gradient-based method, as follows:
Intensity (S_{Ig}): the gradients in the gradient histogram are sorted by intensity,

the top 0.1% are selected, and then their mean (or average) is calculated as the sharpness.
Variance (S_{V}): standard deviation of the gradient histogram.

The spectrum-based method is described as follows. Fourier transform can show the image's spectrum. FIG. 22 shows a cross-section of the spectrum along a horizontal axis (e.g., x-axis). A cross-section of the spectrum of a sharp image is shown by (a) on the left side of FIG. 22, while a cross-section of the spectrum of a blurred image is shown by (b) on the right side of FIG. 22. The cut-off frequency of the sharp image is bigger than the blurred one. This is because the high-frequency signal is repressed in blurred images. In addition, for the bandwidth of the DC region, the sharp image is smaller than the blurred one. The response that the sharp image makes in the low-frequency area is weaker than the blurred one. This is because intensity spreads into high-frequency area. The sharpness of images can be calculated with two indexes in the spectrum-based method, as follows:
Coefficient of variation (COV): COV can be calculated by the following equation, where σₓ and σ_{y} are the standard deviation of the intensity along the x-axis and y-axis in the spectrum, respectively. μₓ and μ_{y} are the means of the intensity along the x-axis and y-axis, respectively.

$${S}_{COV} = \frac{1}{\sqrt{{( \frac{{σ}_{x}}{{μ}_{x}} )}^{2} + {( \frac{{σ}_{y}}{{μ}_{y}} )}^{2}}}$$

Intensity: first normalize the intensity of the spectrum to range 0˜1, then calculate the sum of the spectrum with the following equation. The weak response on the x-axis and y-axis of the spectrum are collected, that is, sum(Iₓ<0.0001) and sum(I_{y}<0.0001), respectively, wherein w and h are the wide and the height of the spectrum. The intensity of a blurred image (S_{Is}) is higher because its response at high frequencies is weaker than a sharp image.

$${S}_{Is} = \sqrt{{( \frac{sum ( {I}_{x} < 0.0001 )}{w} )}^{2} + {( \frac{sum ( {I}_{y} < 0.0001 )}{h} )}^{2}}$$

The USAF resolution benchmark is used herein to analyze the improvement of the proposed method in terms of resolution capability. From the values of SSIM, PSNR, and DoM, it can be seen that the MANtiny model trained with DSD outperforms the model trained with data generated by the Lanczos3 interpolation method, as shown in Table 1 below.

TABLE 1

| | | MANtiny | MANtiny | Lanczos3 |
|---|---|---|---|---|
| | 8K | (based on | (based on | interpolation up |
| | (reference) | DSD) | Lanczos3) | sample |
| PSNR | unavailable | 30.41 | 23.85 | 23.92 |
| SSIM | 1 | 0.9179 | 0.8378 | 0.8402 |
| DoM | 0.6074 | 0.5778 | 0.5305 | 0.5301 |

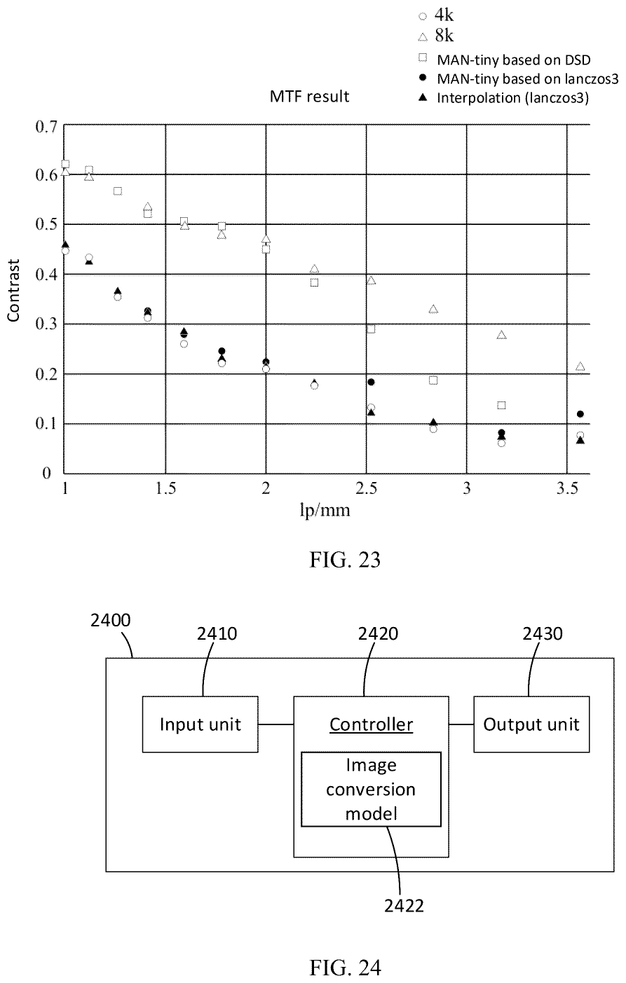

The modulation transfer function (MTF) of each method is shown in FIG. 23. The x-axis is the spatial frequency, which can be seen as the density of the pattern. The y-axis is the contrast, which represents the ability of the system to resolve dense pattern. The method proposed in this application (i.e., DSD) has same performance as 8K when lp/mm<2.24. This means the resolution in this stage is enhanced by the method proposed in this application. The model trained with lanczos3 has no difference as compared to the 4K and interpolation method because it learns how to solve the degradation caused by lanczso3 down-sample, not the degradation process in an optical system.

As shown in FIG. 24, the embodiments of the present application further provide a device 2400 for improving image resolution, which includes an input unit 2410, a controller 2420, and an output unit 2430. The input unit 2410 is configured to receive a low-resolution image. The input unit 2410 includes, but is not limited to, a wired or wireless input interface. The wired input interface includes a USB-C transmission interface, etc., and the wireless input interface includes a WI-FI, Bluetooth, cellular network transmission interface, etc. The controller 2420 is coupled to the input unit 2402. The controller 2420 can also be a controller with arithmetic processing logic (for example, a central processing unit (CPU) or a graphics processing unit (GPU)). An image conversion model 2422 is deployed in the controller 240, and the image conversion model 2422 is configured to convert the low-resolution image into a high-resolution image. The image conversion model 2422 is trained using an image dataset. The image dataset includes a plurality of high-resolution and low-resolution image pairs. Each of the high-resolution and low-resolution image pairs includes a first training image with a first resolution obtained based on a first focal length and a second training image with a second resolution obtained based on a second focal length. The first training image and the second training image have the same or corresponding image content, and the first resolution is greater than the second resolution. The output unit 2430 is coupled to the controller 2420. The output unit 2430 includes, but is not limited to, a display interface, and the output unit 2430 can also be an output interface coupled to a storage unit. The output unit 2430 is configured to output the high-resolution image, wherein the resolution of the high-resolution image is higher than the resolution of the low-resolution image.

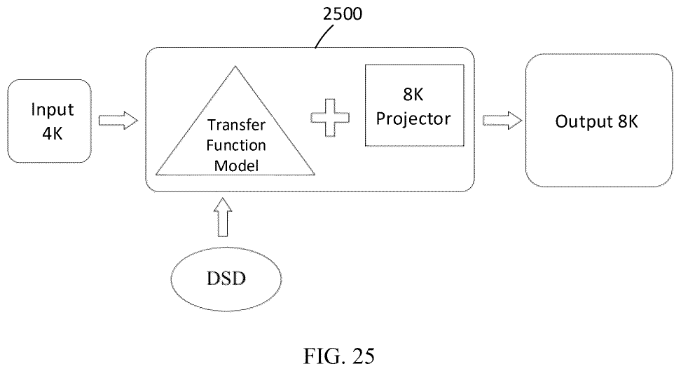

FIG. 25 is a schematic diagram illustrating deployment of a high-resolution

conversion system 2500 according to an embodiment of the present application. A high-resolution conversion model trained by applying the embodiments of the present application can upgrade an input low-resolution image or video to a high-resolution image or video for output. For example, a 4K image can be upgraded to a high-quality image with a resolution of 8K. In addition, the designed scene dataset (i.e., DSD) obtained by applying the concepts of the present invention can be inputted into a trained high-resolution conversion model (e.g., the transfer function model shown in FIG. 22) in the high-resolution conversion system 2500 at any time to further optimize the high-resolution conversion model such that the quality of the images or videos outputted by the high-resolution conversion model can be enhanced, and the flexibility of training the high-resolution conversion model can be improved. In addition, the images or videos converted by the high-resolution conversion model can be directly projected or displayed in real time such that users can instantly perceive the effect of the image conversion, reducing the time users have to wait for the conversion process.

While the preferred embodiments of the present application have been illustrated and described in detail, various modifications and alterations can be made by persons skilled in this art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

What is claimed is:

1. An image data collection system, comprising:
an image capture device, configured to capture an image of an object at a first focal length to obtain a first image and capture an image of the object at a second focal length to obtain a second image, wherein the first image and the second image are of the same resolution;
a storage device, configured to store the first image and the second image captured by the image capture device;
a processing module, obtaining the first image and the second image from the storage device, configured to process the first image to obtain a first processed image with a first resolution, and processing the second image to obtain a second processed image with a second resolution, wherein the first resolution is greater than the second resolution; and
a registration module, obtaining the first processed image and the second processed image from the processing module, configured to perform image alignment on the first processed image and the second processed image to obtain a high-resolution and low-resolution image pair.

2. The image data collection system according to claim 1, wherein the processing module comprises a cropping module configured to crop a first area in the first image to obtain the first processed image and crop a second area in the second image to obtain the second processed image, image content of the first area corresponds to the image content of the second area, and the resolution of the first area is greater than the resolution of the second area.

3. The image data collection system according to claim 2, wherein the first focal length is f1, the second focal length is f2, then f1=A*f2, where A>1, and wherein the resolution of the first area is X, and the resolution of the second area is X/A.

4. The image data collection system according to claim 3, wherein A=2, and the obtained high-resolution and low-resolution image pairs are used to train a model that is suitable for improving image resolution by two times.

5. The image data collection system according to claim 2, wherein the resolution of the first area is greater than or equal to 100×100.

6. The image data collection system according to claim 2, further comprising a standard deviation filter configured to determine whether to remove or keep the cropped image of the first area based on standard deviation of grayscale values of the first image and standard deviation of grayscale values of the image of the first area.

7. The image data collection system according to claim 1, wherein the registration module performs the image alignment based on a difference between phase maps of spectrum of the first processed image and the second processed image.

8. The image data collection system according to claim 7, wherein after the image alignment is performed, if correlation between the first processed image and the second processed image is greater than a certain value, the registration module stores the first processed image and the second processed image as the high-resolution and low-resolution image pair.

9. The image data collection system according to claim 1, wherein the first focal length and the second focal length of the image capture device are determined by performing magnification calibration on a calibration image.

10. The image data collection system according to claim 9, wherein the magnification calibration performed on the calibration image is achieved based on cosine pattern spectrum and Fourier Mellin transform.

11. An image model training method, comprising:
obtaining an image dataset by an optical system, wherein the image dataset comprises a plurality of high-resolution and low-resolution image pairs, each of the high-resolution and low-resolution image pairs comprises a first training image with a first resolution obtained based on a first focal length and a second training image with a second resolution obtained based on a second focal length, the first training image and the second training image have the same or corresponding image content, and the first resolution is greater than the second resolution; and
inputting the image dataset into a neural network model to train the neural network model to obtain a trained image model, wherein the first training image serves as inputs of the neural network model, and the second training image serves as training labels.

12. The image model training method according to claim 11, further comprising:
cropping a first area in the first image to obtain the first training image; and
cropping a second area in a second image to obtain the second training image,
wherein image content of the first area corresponds to the image content of the second area, and the resolution of the first area is greater than the resolution of the second area.

13. The image model training method according to claim 12, wherein the first focal length is f1, the second focal length is f2, then f1=A*f2, where A>1, and wherein the resolution of the first area is X, and the resolution of the second area is X/A.

14. The image model training method according to claim 13, wherein A=2, and the trained image model is a model that is suitable for improving image resolution by two times.

15. The image model training method according to claim 12, further comprising:
determining whether to remove or keep an image of the cropped first area based on standard deviation of grayscale values of the first image and standard deviation of grayscale values of the image of the first area.

16. The image model training method according to claim 12, further comprising:
performing image alignment based on a difference between phase maps of spectrum of the first training image and the second training image.

17. The image model training method according to claim 16, wherein after the image alignment is performed, if correlation between the first training image and the second training image is greater than a certain value, the first training image and the second training image are stored as the high-resolution and low-resolution image pair.

18. The image model training method according to claim 11, further comprising determining a minimum crop size of images in the image dataset, which comprises:
obtaining a high-resolution image and a low-resolution image having image content corresponding to the image content of the high-resolution image;
cropping the high-resolution image based on a plurality of different sizes and capturing the same region in the low-resolution image to obtain a high-resolution and low-resolution image pair; and
determining the minimum crop size based on a result of model training with a use of the high-resolution and low-resolution image pair for each of the sizes.

19. The image model training method according to claim 11, further comprising determining a minimum crop size of images in the image dataset, which comprises:
obtaining a high-resolution image and a low-resolution image having image content corresponding to the image content of the high-resolution image;
performing a fast Fourier transform on the high-resolution image and the low-resolution image to obtain a high-resolution image spectrum and a low-resolution image spectrum, respectively;
for low-frequency areas in the high-resolution image and the low-resolution image, cropping the high-resolution image and the low-resolution image based on a plurality of different sizes; and
determining the minimum crop size from these sizes based on correlation between the high-resolution image spectrum and the low-resolution image spectrum at these sizes.

20. The image model training method according to claim 11, further comprising:
extracting representative images from a video; and
generating high-resolution version and low-resolution version of the representative images to participate in the training of the neural network model.

21. The image model training method according to claim 20, wherein the extracting representative images from the video comprises:
identifying redundant images in the video and/or identifying blurred images in the video; and
excluding at least one of the redundant images or the blurred images in the video, and taking remaining images in the video as the representative images.

22. The image model training method according to claim 21, wherein the identifying the redundant images in the video comprises:
identifying the redundant images by comparing similarity between neighboring image frames.

23. The image model training method according to claim 21, wherein the identifying the blurred images in the video comprises:
identifying the blurry images by evaluating sharpness of the images.

24. A device for improving image resolution, comprising:
an input unit, configured to receive a low-resolution image;
a controller, coupled to the input unit, wherein an image conversion model is deployed in the controller, and the image conversion model is configured to convert the low-resolution image into a high-resolution image, wherein the image conversion model is trained using an image dataset, the image dataset comprises a plurality of high-resolution and low-resolution image pairs, each of the high-resolution and low-resolution image pairs comprises a first training image with a first resolution obtained based on a first focal length and a second training image with a second resolution obtained based on a second focal length, the first training image and the second training image have the same or corresponding image content, and the first resolution is greater than the second resolution; and
an output unit, coupled to the controller, configured to output the high-resolution image, wherein the resolution of the high-resolution image is higher than the resolution of the low-resolution image.
